(19) United States
(12) Patent Application Publication
(10) Pub. No.: US 2009/0136802 A1
(43) Pub. Date: May 28, 2009

(54) SOLID POLYMER FUEL CELL

(75) Inventors: Hideaki Sasaki, Tokyo (JP); Takeshi Obata, Tokyo (JP); Hidekazu Kimura, Tokyo (JP); Suguru Watanabe, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, MINATO-KU, TOKYO (JP)

(21) Appl. No.: 12/297,286

(22) PCT Filed: Apr. 13, 2007
(86) PCT No.: PCT/JP2007/058177

§ 371 Date: Oct. 15, 2008

(30) Foreign Application Priority Data
Apr. 17, 2006 (JP) 2006-1136583

(51) Int. Cl. H01M 8/10

(52) U.S. Cl. 429/19; 429/30

(57) ABSTRACT

A solid polymer fuel cell includes: a membrane and electrode assembly in which a solid polymer electrolyte membrane is sandwiched between a fuel electrode and an oxidant electrode; an oxidant channel which is formed on an oxidant electrode side of the membrane and electrode assembly, and supplies oxidant to the oxidant electrode; and a water-repellent membrane which is formed between the oxidant electrode and the oxidant channel, and has a vapor permeation property. Thus, the solid polymer fuel cell is provided in which the disturbance of the oxidant gas supply that is caused by the deposition and contact of the droplet can be suppressed.

### TECHNICAL FIELD

The present invention relates to a solid polymer fuel cell for generating electric power by using an electrochemical reaction.

### BACKGROUND ART

A solid polymer fuel cell is known which includes a membrane and electrode assembly (hereafter, referred to as MEA) having a structure wherein a solid polymer electrolyte membrane is sandwiched between a fuel electrode and an oxidant electrode. This solid polymer fuel cell is the device in which fuel such as hydrogen and alcohol supplied to the fuel electrode and oxidant gas such as air and oxygen supplied to the oxidant electrode are electrochemically reacted to generate electric power.

In the solid polymer fuel cell, when the fuel such as hydrogen and alcohol is supplied to the fuel electrode, the fuel is decomposed and separated into protons (H⁺) and electrons (e⁻) by catalytic particles supported on the fuel electrode. The protons pass through the solid polymer electrolyte membrane and react with the oxygen in air on the oxidant electrode to generate water. At this time, the electrons pass through an external load and move from the fuel electrode to the oxidant electrode to generate the electric power. Furthermore, the water generated on the oxidant electrode is evaporated by reaction heat resulting from the cell reaction and discharged into an oxidant channel.

Incidentally, a voltage obtained from a unit cell is low in the solid polymer fuel cell. Therefore, a fuel cell stack in which a plurality of unit cells is connected in series is typically used as the solid polymer fuel cell. In the fuel cell stack, when oxidant gas is supplied to each of the plurality of unit cells, there is a case that an oxidant channel is arranged from end to end of the plurality of unit cells. In this case, the drop in the cell output caused by drying of the electrolyte membrane is apt to occur in the unit cells on the upstream side of the oxidant channel. Thus, the relative humidity inside the oxidant channel is adjusted to approximately 100% by supplying humidified oxidant gas. At this time, in the unit cells on the downstream side of the oxidant channel, there is a case that the relative humidity reaches 100%, which brings about condensed water (dew water). This condensed water is apt to be generated on a wall surface of the oxidant channel where a temperature is low even inside the oxidant channel. There is a case that the condensed water is grown to droplet with time, and dropped onto the oxidant electrode surface to be deposited or brought into contact after a while. When the droplet is deposited on or brought into contact with the oxidant electrode surface, supply of the oxidant gas to the oxidant electrode is disturbed. Hence, a technique is desired, which can suppress the disturbance of the oxidant gas supply that is caused by the deposition and contact of the droplet.

In conjunction with the foregoing technique, Japanese Laid-Open Patent Application (JP-P2003-331900A) describes a technique in which in order to protect the water generated with the electric power generation from being leaked from the solid polymer fuel cell because it cannot be sufficiently diffused into atmosphere, a water absorbing layer is included between an oxygen permeation holes and a cathode electricity collector.

Japanese Laid-Open Patent Application (JP-P 2004-22254A) describes a fuel cell in which in order to improve the extraction efficiency of generated electric power, a plurality of unit cells is stacked and each unit cell includes: a fuel electrode configured by a gas diffusion electrode composed of a catalyst layer and a water-repellent gas diffusion layer; an oxidant electrode; an electric power generation portion composed of a solid polymer electrolyte membrane that is sandwiched between this pair of the electrodes; and a separator for separating the fuel and the oxidant, wherein the gas diffusion electrode is configured by the catalyst layer and the gas diffusion layer which includes the water-repellent material on which a water repelling process is performed except the catalyst layer. Here, it is described that the catalyst layer is formed on the surface in contact with the solid polymer electrolyte membrane of the gas diffusion layer prior to the water repelling process and dose not include a water repelling agent.

Also, Japanese Laid-Open Patent Application (JP-P 2004-140001A) describes a fuel cell that includes: a solid electrolyte membrane; a fuel electrode and an oxidant electrode between which the solid electrolyte membrane is sandwiched; and a liquid fuel supplying unit for supplying liquid fuel to the fuel electrode, wherein the oxidant electrode includes a substrate and a catalyst layer formed between the substrate and the solid electrolyte membrane, and inside the substrate, a hydrophobic first layer and a hydrophilic second layer are formed in this order, from the side of the catalyst layer to the outside of the cell.

Also, Japanese Laid-Open Patent Application (JP-P 2005-38780A) describes a solid polymer fuel cell having an electrode in which a separator, a gas diffusion layer and a catalyst layer are laminated in this order, wherein a retaining groove for retaining the water generated with electric power generation reaction is formed on the lamination surface of the gas diffusion layer or catalyst layer, and a layer existing on the separator side of the retaining groove is composed of: a hydrophilic part formed in a portion opposite to the retaining groove; and a hydrophobic part formed in a portion which is not opposite to the retaining groove, and the separator is porous.

Also, Japanese Laid-Open Patent Application (JP-A-Heisei, 6-5289) discloses a polymer electrolyte fuel cell, characterized by having an electrode in which at least a part is made of foam metal.

In order not to disturb air supply to the oxidant electrode, there is a case of adding an idea to the oxidant electrode itself. However, when properties of the oxidant electrode itself are changed, there is a case that, a contact resistance is increased if an insulation coating is formed, or various properties are influenced if the shape is changed. Thus, a technique is desired which can protect the air supply to the oxidant electrode from being disturbed without any change in the properties of the oxidant electrode itself.

### DISCLOSURE OF INVENTION

An object of the present invention is to provide a solid polymer fuel cell in which a disturbance of oxidant gas supply that is caused by deposition and contact of droplet can be suppressed.

Another object of the present invention is to provide a solid polymer fuel cell in which the oxidant gas supply disturbance caused by the deposition and contact of the droplet can be suppressed without any change in the properties of an oxidant electrode itself.

The solid polymer fuel cell of the present invention includes: a membrane and electrode assembly in which a solid polymer electrolyte membrane is sandwiched between a fuel electrode and an oxidant electrode; an oxidant channel which is formed on an oxidant electrode side of the membrane and electrode assembly and supplies oxidant to the oxidant electrode; and a water-repellent membrane which is formed between the oxidant electrode and the oxidant channel and has an air permeation property and a vapor permeation property.

According to the present invention, since the water-repellent membrane has the air permeation property, the oxidant gas is supplied through the water-repellent membrane to the oxidant electrode. At this time, even if the relative humidity inside the oxidant channel is increased and condensed water is generated, the condensed water is not brought into contact with the oxidant electrode because there is the water-repellent membrane. Also, by the water-repellent action, an area where the droplet is brought into contact with the water-repellent membrane is decreased, and thus, the oxidant gas supply disturbance is small. Moreover, by the vapor permeation property of the water-repellent membrane, the water generated on the oxidant electrode is exhausted through the oxidant channel. Therefore, there is no case that the water is accumulated on the oxidant electrode side and then the accumulated water is condensed and brought into contact with the oxidant electrode.

Preferably, the water-repellent membrane may be a porous membrane.

In one aspect, preferably, the water-repellent membrane may be closely-attached to the oxidant electrode.

In another aspect, a gap may be preferably formed between the oxidant electrode and the water-repellent membrane.

Preferably, an air permeability rate of the water-repellent membrane may be higher than a highest air consumption rate in the oxidant electrode at the time of electric power generation, and the vapor permeability rate of the water-repellent membrane may be higher than a highest water generation rate in the oxidant electrode at the time of the electric power generation.

Preferably, a contact angle between the water-repellent membrane and water may be 90 degrees or more.

Preferably, the water-repellent membrane may include polytetrafluoroethylene.

Preferably, the solid electrolyte type fuel cell may further include a fuel vaporizing unit which vaporizes liquid fuel and supplies to the fuel electrode, when the liquid fuel is used as fuel to be supplied to the fuel electrode.

According to the present invention, the solid polymer fuel cell is provided in which the disturbance of the oxidant gas supply that is caused by the deposition and contact of the droplet can be suppressed.

According to the present invention, moreover, the solid polymer fuel cell is provided in which the oxidant gas supply disturbance caused by the deposition and contact of the droplet can be suppressed without any change in the various properties of the oxidant electrode itself.

### BRIEF DESCRIPTION OF THE DRAWINGS

FIG. 1 is a sectional view showing a unit cell structure in a first exemplary embodiment.

FIG. 2 is a sectional view showing a unit cell structure in a second exemplary embodiment.

FIG. 3 is a sectional view showing a unit cell structure in a third exemplary embodiment.

FIG. 4 is a view showing properties of fuel cells used in an example and a comparison example.

### BEST MODE FOR CARRYING OUT THE INVENTION

### First Exemplary Embodiment

The first exemplary embodiment of the present invention will be described below with reference to the drawings.

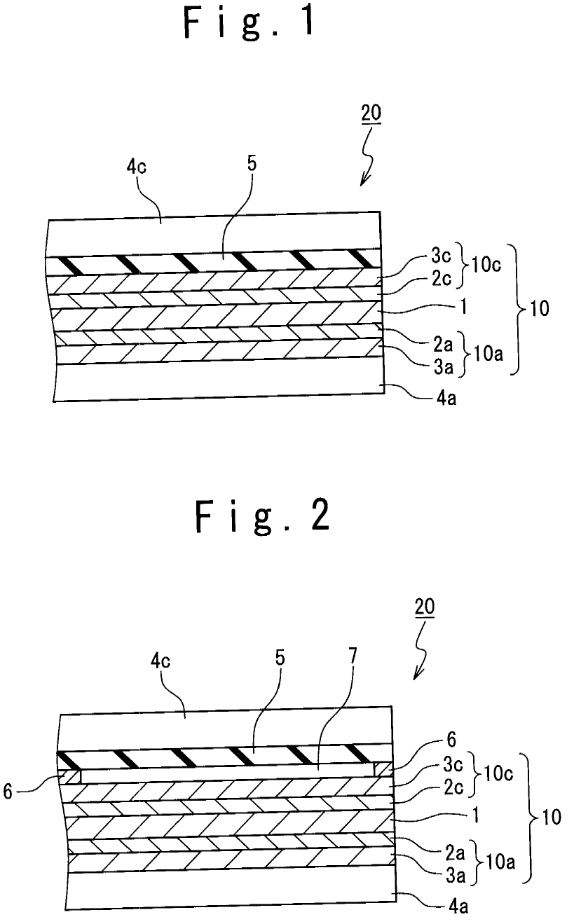

FIG. 1 is a sectional view of a unit cell of a solid polymer fuel cell 20 in the first exemplary embodiment. The solid polymer fuel cell 20 includes a membrane and electrode assembly 10 (hereafter, referred to as MEA), a water-repellent porous membrane 5, a fuel channel 4a and an oxidant channel 4c.

The MEA 10 is formed such that both surfaces of a solid polymer electrolyte membrane 1 are sandwiched between a fuel electrode 10a (anode) and an oxidant electrode 10c (cathode). The fuel electrode 10a includes: an anode catalyst layer 2a formed on the side of the solid polymer electrolyte membrane 1; and an anode gas diffusion electrode 3a formed on the anode catalyst layer 2a. The oxidant electrode 10c similarly includes: a cathode catalyst layer 2c formed on the side of the solid polymer electrolyte membrane 1; and a cathode gas diffusion electrode 3c formed on the cathode catalyst layer 2c. On the cathode gas diffusion electrode 3c, the water-repellent porous membrane 5 is closely-attached and formed on the cathode gas diffusion electrode 3c. An oxidant channel 4c is formed on the water-repellent porous membrane 5. In the opposite side, a fuel channel 4a is formed on the anode gas diffusion electrode 3a.

The MEA 10 and the water-repellent porous membrane 5 are enclosed in a chassis (not shown). Concave portions are formed inside this chassis, and these concave portions serve as the oxidant channel 4c and the fuel channel 4a. The fuel channel 4a is configured such that the fuel such as hydrogen and alcohol is supplied. The oxidant channel 4c is configured such that the oxidant gas such as air and oxygen is supplied. The fuel supplied to the fuel channel 4a is supplied to the fuel electrode 10a. In the opposite side, the oxidant gas such as air and oxygen is supplied to the oxidant channel 4c. The oxidant gas supplied to the oxidant channel 4c is supplied through the water-repellent porous membrane 5 to the oxidant electrode 10c.

In the anode catalyst layer 2a, protons and electrons are taken out from the fuel supplied to the fuel electrode 10a. The anode catalyst layer 2a can be configured by the mixture of: particles (including powder) in which catalysts are supported on supports such as carbon or catalysts themselves which are not supported; and proton conductors. The catalyst is exemplified by platinum, rhodium, palladium, iridium, osmium, ruthenium, rhenium, gold, silver, nickel, cobalt, molybdenum, lanthanum, strontium, and yttrium. As for the catalyst, only one kind of these materials may be used, and two or more kinds of them may be combined and used. The particle supporting the catalyst is exemplified by carbon-based material such as acetylene black, ketjen black, carbon nanotube, and carbon nanohorn. The size of the particle is properly selected within a range between about 0.01 and 0.1 μm, preferably within a range between 0.02 and 0.06 μm, for example, when the carbon-based material is particle-shaped. In order to make the particle support the catalyst, for example, a colloid method can be applied. Catalyst amounts per unit area of the anode and the cathode can be properly selected within a range between about 0.1 mg/cm² and 20 mg/cm², based on the kind, size and the like of the catalyst.

In the cathode catalyst layer 2c, the oxidant gas supplied to the oxidant electrode 10c reacts with the protons and the electrons to generate the water. As for the cathode catalyst layer 2c, it is possible to use the materials similar to the anode catalyst layer 2a.

The anode gas diffusion electrode 3a and the cathode gas diffusion electrode 3c are provided to diffuse the fuel to the anode catalyst layer 2a and the oxidant gas to the cathode catalyst layer 2c, respectively. As those materials, conductive porous material can be used, for example, such as a carbon paper, a carbon molded body, a carbon sintered body, a sintered metal, and a foamed metal. The material having a thickness between 100 μm and 300 μm is preferably used. Also, the material having a porous rate between 40% and 90% is preferably used.

As the solid polymer electrolyte membrane 1, the polymer membrane is preferably used which has the corrosion resistance against fuel and has the high proton conductivity and does not have the electronic conductivity. The solid polymer electrolyte membrane 1 is exemplified by ion exchange resin that has the polar group of: a strong acid group such as a sulfone group, a phosphate group, a phosphonate group, and a phosphine group; and a weak acid group such as a carboxyl group. The specific example of the ion exchange resin is exemplified by a perfluorosulfonic acid resin, a sulfonation polyether sulfonic acid resin, and a sulfonation polyimide resin. Further specifically, the solid polymer electrolyte membrane is exemplified by a membrane composed of an aromatic series polymer such as sulfonation poly (4-phenoxy benzoyl-1,4-phenylene), sulfonation polyether ether ketone, sulfonation polyether sulfone, sulfonation polysulfone, sulfonation polyimide, and alkyl sulfonation polybenzimidazole. The thickness of the solid polymer electrolyte membrane 1 can be properly selected within a range between about 10 and 300 μm, based on the material and the application of the fuel cell.

The water-repellent porous membrane 5 has an air permeation property higher than a consumption rate of air which is consumed in the electric power generation reaction. Since the water-repellent porous membrane 5 has the high air permeation property, the oxidant supply to the oxidant electrode 10c from the oxidant channel 4c is not blocked by the water-repellent porous membrane 5. The water-repellent porous membrane 5 is preferably used whose air permeability (the Gurley test method JIS P8117) is 20 sec or less, although it depends on the electric power generation condition.

The water-repellent porous membrane 5 has a vapor permeation property higher than a generation rate of vapor which is generated on the oxidant electrode 10c in the electric power generation reaction. Since the water-repellent porous membrane 5 has the vapor permeation property, the water generated on the oxidant electrode 10c is exhausted to the oxidant channel 4c. As a result, there is no case that the water is deposited on the oxidant electrode 10c and the supply of the oxidant gas is disturbed. The water-repellent porous membrane 5 is preferably used whose moisture permeability (JIS K7129A) is 7000 (g/m² day) or more, although it depends on the electric power generation condition.

The water-repellent porous membrane 5 is the porous material. The shape in which a thickness is between 10 and 100 μm, a hole diameter is between 0.1 and 3 μm, and a porosity is between 70 and 90% is preferably used. When this shape is used, the high air permeation property and the high vapor permeation property can be obtained. Also, a surface of the water-repellent porous membrane 5 is sufficiently smooth, as compared with the cathode gas diffusion electrode 3c.

The water-repellent porous membrane 5 has the water-repellency. Since the water-repellent porous membrane 5 has the water-repellency, even if droplet of dew water generated in the oxidant channel 4c is deposited on the water-repellent porous membrane 5, the droplet does not spread. As a result, the supply disturbance of the oxidant gas is minimized. As a criterion of the water-repellency, a contact angle with the water is desired to be 90 degrees or more.

As material for the water-repellent porous membrane 5, for example, polyethylene, polytetrafluoroethylene (PTFE), the porous membrane composed of the copolymer thereof, water-repellent-processed polyethersulfone and acryl copolymer can be used. Among them, the PTFE porous membrane is superior in water-repellency, chemical resistance, mechanical property and the like. Thus, the PTFE porous membrane is further preferable as the water-repellent porous membrane 5. Incidentally, the water-repellent porous membrane 5 may be the multi-layer membrane in which membranes of different kinds are laminated. In the case of the multi-layer membrane, when the side of the oxidant channel 4c has the sufficient water-repellency, the side of the oxidant electrode 10c is allowed to be hydrophilic.

The action of the foregoing solid polymer fuel cell will be described below. When electric power is generated, the fuel such as the hydrogen and alcohol is supplied to the fuel channel 4a. On the opposite side, the oxidant gas such as air and oxygen is supplied to the oxidant channel 4c.

The fuel supplied to the fuel channel 4a is supplied through the anode gas diffusion electrode 3a to the anode catalyst layer 2a. The fuel is decomposed in the anode catalyst layer 2a. Consequently, protons and electrons are generated. The electrons are sent out to an external circuit (not shown) and sent through the external circuit to the oxidant electrode. The protons reach the oxidant electrode 10c through the solid polymer electrolyte membrane 1 and react with the oxidant gas that is supplied to the oxidant electrode 10c. Consequently, water is generated.

Here, even if a relative humidity of the oxidant channel 4c exceeds 100% and then condensed water is generated on a wall surface of the oxidant channel 4c and the like, by the existence of the water-repellent porous membrane 5, the water is never brought into direct contact with a surface of the oxidant electrode 10c. Also, even if droplet is brought into contact with the water-repellent porous membrane 5, the droplet becomes spherical and does not spread onto the membrane surface. As a result, the disturbance of the supply of the oxidant gas can be minimized. Moreover, since the surface of the water-repellent porous membrane 5 is smooth, the droplet deposited on the surface of the water-repellent porous membrane 5 is smoothly exhausted by the flow of the oxidant gas inside the oxidant channel 4c.

Incidentally, when the air permeation property of the water-repellent porous membrane 5 is set to be higher than the highest air consumption rate in the oxidant electrode at the time of the electric power generation, and when the vapor permeation property of the water-repellent porous membrane 5 is set to be higher than the highest water generation rate in the oxidant electrode at the time of the electric power generation, the intake of the air necessary for the electric power generation and the exhaustion of the vapor generated by the electric power generation are sufficiently executed. As a result, even if the water-repellent porous membrane 5 is formed, the cell output is not substantially dropped.

In this exemplary embodiment, the water-repellent porous membrane 5 is closely-attached and formed on the cathode gas diffusion electrode 3c. Thus, heat generated in the cathode gas diffusion electrode 3c is efficiently conducted to the water-repellent porous membrane 5. As a result, condensation of the vapor is hard to occur inside the water-repellent porous membrane 5 and on the surface thereof. Hence, it is possible to further suppress the permeation of the oxidant gas and vapor in the water-repellent porous membrane 5 from being disturbed by the condensed water.

### Second Exemplary Embodiment

The second exemplary embodiment of the present invention will be described below. FIG. 2 is a sectional view of an unit cell of the solid polymer fuel cell in the second exemplary embodiment. In this exemplary embodiment, a spacer 6 is added between the cathode gas diffusion electrode 3c and the water-repellent porous membrane 5, as compared with the first exemplary embodiment. The spacer 6 is provided in the shape of a frame correspondingly to the outer circumference of the MEA 10. With this spacer 6, a gap 7 is formed between the water-repellent porous membrane 5 and the cathode gas diffusion electrode 3c. The configurations except the spacer 6 and gap 7 are similar to the first exemplary embodiment. Thus, the explanations are omitted.

According to this exemplary embodiment, the gap 7 exists between the cathode gas diffusion electrode 3c and the water-repellent porous membrane 5. Thus, the concentration of the oxidant gas supplied to the oxidant electrode 10c through the water-repellent porous membrane 5 can be made homogeneous, independently of a position. That is, even if droplet is brought into contact with the water-repellent porous membrane 5, the supply of the oxidant gas is not locally disturbed, and thus, the locally-dropping of the concentration of the oxidant gas supplied to the oxidant electrode 10c can be suppressed.

The thickness of the gap 7 is desired to be between 0.1 and 0.5 mm. In the case of the thickness of 0.1 mm or less, it is difficult to homogeneously supply the oxidant gas even through the gap 7. On the other hand, in the case of the thickness thicker than 0.5 mm, it is difficult to sufficiently supply the oxidant gas.

Incidentally, in this exemplary embodiment, since the water-repellent porous membrane 5 is arranged through and the gap 7 on the cathode gas diffusion electrode 3c generating the heat, a temperature of the water-repellent porous membrane 5 is slightly dropped as compared with that of the first exemplary embodiment. Thus, there is a case that vapor inside the water-repellent porous membrane 5 and on the surface thereof are easily condensed as compared with that of the first exemplary embodiment. By considering such situations, it is desired to make the thickness of the water-repellent porous membrane 5 thinner or make the hole diameter and the porosity larger for properly adjusting of the shape of the water-repellent porous membrane 5, correspondingly to the configuration.

### Third Exemplary Embodiment

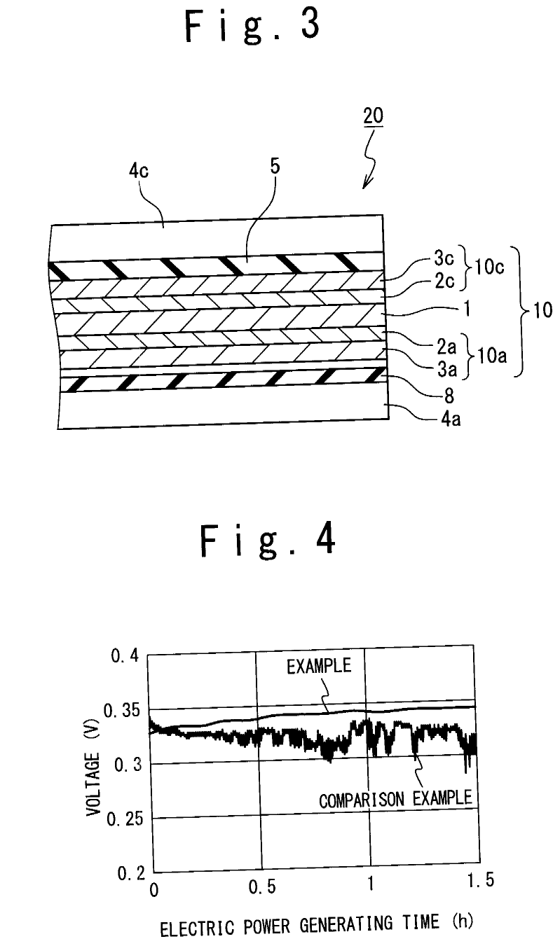

The third exemplary embodiment of the present invention will be described below. FIG. 3 is a sectional view of an unit cell of the solid polymer fuel cell in the third exemplary embodiment. As compared with the first exemplary embodiment, a fuel evaporator 8 is added between the fuel electrode 10a and the fuel channel 4a. Also, in this exemplary embodiment, the solid polymer fuel cell is assumed to be a direct methanol type fuel cell in which liquid fuel such as methanol aqueous solution as the fuel is directly supplied without any reforming. The other configurations are similar to the first exemplary embodiment. Thus, their explanations are omitted.

The fuel evaporator 8 performs a gas liquid separation for the liquid fuel flowing through the fuel channel 4a. That is, the liquid fuel (methanol) is evaporated by the fuel evaporator 8, and only the gas component is selectively supplied to the fuel electrode 10a.

As the fuel evaporator 8, a gas liquid separation membrane and a vapor permeation membrane are preferably used. The gas liquid separation membrane may have the gas permeation performance to supply the evaporation fuel necessary for the electric power generation, and the same materials as the water-repellent porous membrane 5 can be used. Also, a non-porous vapor permeation membrane can be used. Specifically, the polymer electrolyte membrane having the ion exchange group can be used. When the polymer electrolyte membrane having the ion exchange group is used, by the hydrating action, the fuel on the side of the fuel channel 4a of the membrane is permeated to the fuel electrode 10a through the concentration diffusion. Then, the evaporated fuel is supplied to the fuel electrode 10a.

Incidentally, it may be configured such that the fuel evaporator 8 is separately placed outside the fuel cell stack and then the evaporated fuel is supplied into the fuel channel.

In the direct methanol fuel cell, there is a case that, when the liquid fuel is supplied in its original state to the fuel electrode 10a, water excessively accumulates in the fuel electrode 10a. The excessive water crosses over to the oxidant electrode 10c through the solid polymer electrolyte membrane 1, and the water is excessively supplied to the oxidant electrode 10c. In this case, there is a case that the water which cannot be evaporated on the oxidant electrode 10c accumulates between the cathode gas diffusion electrode 3c and the water-repellent porous membrane 5 and consequently the intake of the air is disturbed.

According to this exemplary embodiment, since the fuel evaporator 8 is provided, the liquid fuel is evaporated and supplied to the fuel electrode 10a. As a result, the liquid fuel is not in direct contact with the fuel electrode 10a. Also, since the fuel is not supplied beyond necessity, the crossover amount can be reduced. Since the water quantity of the crossover is reduced, dew water in the oxidant electrode 10c is suppressed. Thus, the protection effect of the oxidant gas supply disturbance that results from the formation of the water-repellent porous membrane 5, which is the idea in the first exemplary embodiment, can be synergistically increased.

Incidentally, depending on conditions such as the humidification, the flow rate and the temperature of the air supplied to the oxidant channel 4c, there is a case that the humidity of the air inside the oxidant channel 4c is not sufficient, then the solid polymer electrolyte membrane 1 is dried, and consequently, the ion conductivity is dropped and the cell output is reduced. In this case, a humidity keeping layer (not shown) may be formed between the oxidant electrode 10c and the water-repellent porous membrane 5. By the humidity keeping layer, vaporization of the water from the oxidant electrode is suppressed, which can protect the solid polymer electrolyte membrane from being dried. As the humidity keeping layer, fiber resin such as cellulose, foam resin such as polyurethane, and porous body made of inorganic material such as glass wool can be preferably used.

The examples experimented by the inventors will be described below.

### EXAMPLE 1

Catalyst supporting carbon particles in which platinum particles whose particle diameter was within a range between 3 and 5 nm were supported at a weight ratio of 50% by carbon particles (Ketjen Black EC600JD made by Lion Corporation) was prepared. Nafion aqueous solution (Bland Name: DE521, “Nafion” is a registered trademark of Du Pont) of 5 weight % made by Du Pont was added to this catalyst supporting carbon particles of 1 g. Then, this was agitated to obtain the catalyst paste for cathode formation. The catalyst paste for anode formation was obtained under the same condition as the catalyst paste for the cathode formation, except the use of the platinum (Pt)-ruthenium (Ru) alloy particles (the rate of Ru is 50 at %) whose particle diameter was within a range between 3 and 5 nm, instead of the platinum particles. The catalyst paste for the cathode formation was coated at the coating amount between 1 and 8 mg/cm² on the cathode gas diffusion electrode 3c of 4 cm×4 cm, and dried to form the cathode catalyst layer 2c. Similarly, the catalyst paste for the anode formation was used to form the anode catalyst layer 2a on the anode gas diffusion electrode 3a.

Next, a membrane that was made of Nafion 117 (a number average molecular weight was 250000) made by Du Pont and had the size of 5 cm×5 cm×180 μm in thickness was prepared as the solid polymer electrolyte membrane 1. The electrode with the catalyst layer produced as mentioned above was arranged such that the catalyst layer side faces the solid polymer electrolyte membrane 1, and the solid polymer electrolyte membrane 1 was hot-pressed from both sides. Consequently, the MEA 10 in which the fuel electrode 10a and the oxidant electrode 10c were joined to the solid polymer electrolyte membrane 1 was obtained.

The water-repellent porous membrane 5 (the hole diameter: 0.6 μm, the thickness: 25 μm, and the porosity: 85%) was closely-attached on the side of the cathode gas diffusion electrode 3c in the produced MEA 10, and the gas liquid separation membrane 8 (the same membrane as the foregoing water-repellent porous membrane 5) was closely-attached on the side of the anode gas diffusion electrode 3a. Moreover, the resin frames having the box shape in which the oxidant channel 4c and the fuel channel 4a were respectively formed were prepared. The MEA 10 in which the water-repellent porous membrane 5 and the gas liquid separation membrane 8 were arranged was sandwiched by the resin frames from both sides, and consequently, the unit cell having the configuration shown in FIG. 3 was obtained. Incidentally, although not shown in the drawing, current terminals were connected to the anode gas diffusion electrode 3a and the cathode gas diffusion electrode 3c, and the supply port and exhaustion port for the fuel and oxidant were provided in the resin frames. The produced ten unit cells were connected in series, and the supply port and the exhaustion port of the fuel (oxidant) were connected in series, and the fuel cell stack in which the respective unit cells were connected in series was prepared.

### EXAMPLE 2

As shown in FIG. 2, the spacer 6 (the thickness: 0.2 mm) was placed between the cathode gas diffusion electrode 3c and the water-repellent porous membrane 5. Then, the water-repellent porous membrane 5 was not closely-attached to the cathode gas diffusion electrode 3c, and the gap of 0.2 mm was formed, and the fuel cell stack was prepared. The other configurations were designed to be equal to the first example.

### COMPARISON EXAMPLE

The configurations except that the water-repellent porous membrane 5 was not formed were designed to be similar to the examples, and the fuel cell stack of the comparison example was prepared.

### (Experiment Condition)

FIG. 4 shows a result of aged deteriorations in average voltages per unit cell in the fuel cell stacks in the examples 1, 2 and the comparison example, when the electric power is generated at 125 mA/cm². Incidentally, as the fuel, 10 vol % methanol aqueous solution was used, and this was supplied at the flow rate of about 30 cc/min into the fuel channel 4a. The humidified air of a room temperature was used as the oxidant gas. Then, this was supplied at a flow rate of about 600 cc/min into the oxidant channel 4c, and the electric power was generated. As shown in FIG. 4, in the fuel cell of the comparison example, the voltage was unstable and indicated the tendency that the voltage was reduced with time. On the contrary, in the fuel cells of the examples 1, 2, the electric power generation was stably kept. Here, since the substantially same results were obtained in both of the example 1 and the example 2, both are collectively indicated as the example in FIG. 4.

From the foregoing experiment result, it is confirmed that the formation of the water-repellent porous membrane 5 effectively protects the air supply disturbance caused by the condensed water generated inside the oxidant channel 4c flowing into the oxidant electrode 10c.

1. A solid polymer fuel cell comprising:
a membrane and electrode assembly in which a solid polymer electrolyte membrane is sandwiched between a fuel electrode and an oxidant electrode;
an oxidant channel which is formed on an oxidant electrode side of said membrane and electrode assembly, and supplies oxidant to said oxidant electrode; and
a water-repellent membrane which is formed between said oxidant electrode and said oxidant channel, and has a vapor permeation property,
wherein a gap is formed between said oxidant electrode and said water-repellent membrane.

2. The solid polymer fuel cell according to claim 1, wherein said water-repellent membrane is a porous membrane.

3. (canceled)

4. (canceled)

5. The solid polymer fuel cell according to claim 1, wherein an air permeability rate of said water-repellent membrane is higher than a highest air consumption rate in said oxidant electrode at the time of electric power generation, and
wherein a vapor permeability rate of said water-repellent membrane is higher than a highest water generation rate in said oxidant electrode at the time of said electric power generation.

6. The solid polymer fuel cell according to any of claims 1, wherein a contact angle between said water-repellent membrane and water is 90 degrees or more.

7. The solid polymer fuel cell according to any of claims 1, wherein said water-repellent membrane includes polytetrafluoroethylene.

8. The solid polymer fuel cell according to any of claims 1, further comprising:
a fuel vaporizing unit which vaporizes liquid fuel and supplies to said fuel electrode.

9. The solid polymer fuel cell according to claim 2, wherein an air permeability rate of said water-repellent membrane is higher than a highest air consumption rate in said oxidant electrode at the time of electric power generation, and
wherein a vapor permeability rate of said water-repellent membrane is higher than a highest water generation rate in said oxidant electrode at the time of said electric power generation.

10. The solid polymer fuel cell according to claim 2, wherein a contact angle between said water-repellent membrane and water is 90 degrees or more.

11. The solid polymer fuel cell according to claim 2, wherein said water-repellent membrane includes polytetrafluoroethylene.

12. The solid polymer fuel cell according to claim 2, further comprising:
a fuel vaporizing unit which vaporizes liquid fuel and supplies to said fuel electrode.

13. The solid polymer fuel cell according to claim 5, wherein a contact angle between said water-repellent membrane and water is 90 degrees or more.

14. The solid polymer fuel cell according to claim 5, wherein said water-repellent membrane includes polytetrafluoroethylene.

15. The solid polymer fuel cell according to claim 5, further comprising:
a fuel vaporizing unit which vaporizes liquid fuel and supplies to said fuel electrode.

16. The solid polymer fuel cell according to claim 9, wherein a contact angle between said water-repellent membrane and water is 90 degrees or more.

17. The solid polymer fuel cell according to claim 9, wherein said water-repellent membrane includes polytetrafluoroethylene.

18. The solid polymer fuel cell according to claim 9, further comprising:
a fuel vaporizing unit which vaporizes liquid fuel and supplies to said fuel electrode.
